(19) United States
(12) Patent Application Publication
(10) Pub. No.: US 2020/0218700 A1
(43) Pub. Date: Jul. 9, 2020

(54) IMAGE SYNCHRONIZED STORAGE METHOD AND IMAGE PROCESSING DEVICE

(71) Applicant: SZ DJI TECHNOLOGY CO., LTD., Shenzhen (CN)

(72) Inventors: Yuanhua ZHENG, Shenzhen (CN); Fangpei YANG, Shenzhen (CN)

(21) Appl. No.: 16/825,442

(22) Filed: Mar. 20, 2020

Related U.S. Application Data
(63) Continuation of application No. PCT/CN2017/103238, filed on Sep. 25, 2017.

(51) Int. Cl. G06F 16/178; G06T 1/20; G06T 1/60; G06F 16/51

(52) U.S. Cl. CPC G06F 16/1787; G06F 16/51; G06T 1/60; G06T 1/20

(57) ABSTRACT

The present disclosure provides an image processing device. The image processing device includes a processor, a communication interface, and a first memory. The processor is connected to a correspondent processor through the communication interface. The processor is configured to receive a synchronization notification event and an image identifier sent by the correspondent processor; and synchronously store an image corresponding to the image identifier to the first memory according to the synchronization notification event. The image corresponding to the image identifier is used as the first frame or the last frame of a video.

### CROSS-REFERENCE TO RELATED APPLICATION

This application is a continuation of International Application No. PCT/CN2017/103238, filed Sep. 25, 2017, the entire content of which is incorporated herein by reference.

### TECHNICAL FIELD

The present disclosure generally relates to the field of data storage and, more particularly, relates to an image synchronized storage method and image processing devices.

### BACKGROUND

In recording videos using a camera, original image data (raw format) and proxy image data are often involved. The original image data can be used as the original material for later editing, and the proxy image data is used for quickly confirming the recorded content. During storage, the original image data is stored in a solid state drive (SSD), and the proxy image data is stored in a secure digital (SD) card.

At present, the SSD and SD card in a camera are managed by their respective processor (e.g., CPUs) for data storage. Due to the difference in the time taken by the processors to respectively process the original image data and the proxy image data, and the difference in the delays of the two processors receiving the start storage command or the end storage command, the first frame and the last frame of a same video stored in the SSD and the SD card may be out of sync, and other image frames between the first frame and the last frame may also be out of sync. As such, during the later editing of the original material, the user may not be able to confirm the original image data through the proxy image data.

The disclosed image synchronized storage method and image processing devices are directed to solve one or more problems set forth above and other problems in the art.

### SUMMARY

One aspect of the present disclosure provides an image processing device. The image processing device includes a processor, a communication interface, and a first memory. The processor is connected to a correspondent processor through the communication interface. The processor is configured to receive a synchronization notification event and an image identifier sent by the correspondent processor; and synchronously store an image corresponding to the image identifier to the first memory according to the synchronization notification event. The image corresponding to the image identifier is used as the first frame or the last frame of a video.

Another aspect of the present disclosure provides an image processing device. The image processing device includes a processor, a communication interface, and a second memory. The processor is connected to a correspondent processor through the communication interface. The processor is configured to send a synchronization notification event and an image identifier to the correspondent processor; and process an image corresponding to the image identifier into an image in a predetermined format and store the image in the predetermined format into the second memory according to the synchronization notification event. The image corresponding to the image identifier is used as the first frame or the last frame of a video.

Other aspects of the present disclosure can be understood by those skilled in the art in light of the description, the claims, and the drawings of the present disclosure.

### BRIEF DESCRIPTION OF THE DRAWINGS

In order to more clearly illustrate the technical solutions in the embodiments of the present disclosure, the drawings that need to be used in the description of the embodiments will be briefly described below. It is obvious that the drawings in the following description are some embodiments of the present disclosure, and for those of ordinary skill in the art, other drawings may also be obtained according to these drawings without any creative effort.

FIG. 1 illustrates a schematic diagram of an application scenario of an exemplary image synchronized storage method according to various embodiments of the present disclosure;

FIG. 2 illustrates a schematic flowchart of an exemplary image synchronized storage method according to various embodiments of the present disclosure;

FIG. 3 illustrates a schematic flowchart of another exemplary image synchronized storage method according to various embodiments of the present disclosure;

FIG. 4 illustrates a schematic flowchart of another exemplary image synchronized storage method according to various embodiments of the present disclosure;

FIG. 5 illustrates a schematic structural diagram of an exemplary image processing device according to various embodiments of the present disclosure;

FIG. 6 illustrates a schematic structural diagram of another exemplary image processing device according to various embodiments of the present disclosure; and

FIG. 7 illustrates a schematic structural diagram of another exemplary image processing device according to various embodiments of the present disclosure.

### DETAILED DESCRIPTION OF THE EMBODIMENTS

In the following, the technical solutions in the embodiments of the present disclosure will be clearly described with reference to the accompanying drawings in the embodiments of the present disclosure. It is obvious that the described embodiments are only a part of the embodiments of the present invention, but not all of the embodiments. All other embodiments obtained by those skilled in the art based on the embodiments of the present disclosure without creative efforts are within the scope of the present disclosure.

It should be noted that when a component is referred to as being “fixed” to another component, it can be directly on the other component or an intermediate component may be present. When a component is considered as “connected to” another component, it can be directly connected to another component or both may be connected to an intermediate component.

All technical and scientific terms used herein have the same meaning as commonly understood by one of ordinary skill in the art to which this disclosure belongs, unless otherwise defined. The terminology used in the description of the present disclosure is for the purpose of describing particular embodiments and is not intended to limit the disclosure. The term “and/or” used herein includes any and all combinations of one or more of the associated listed items.

Some embodiments of the present disclosure are described in detail below with reference to the accompanying drawings. The features of the embodiments and examples described below can be combined with each other without conflict.

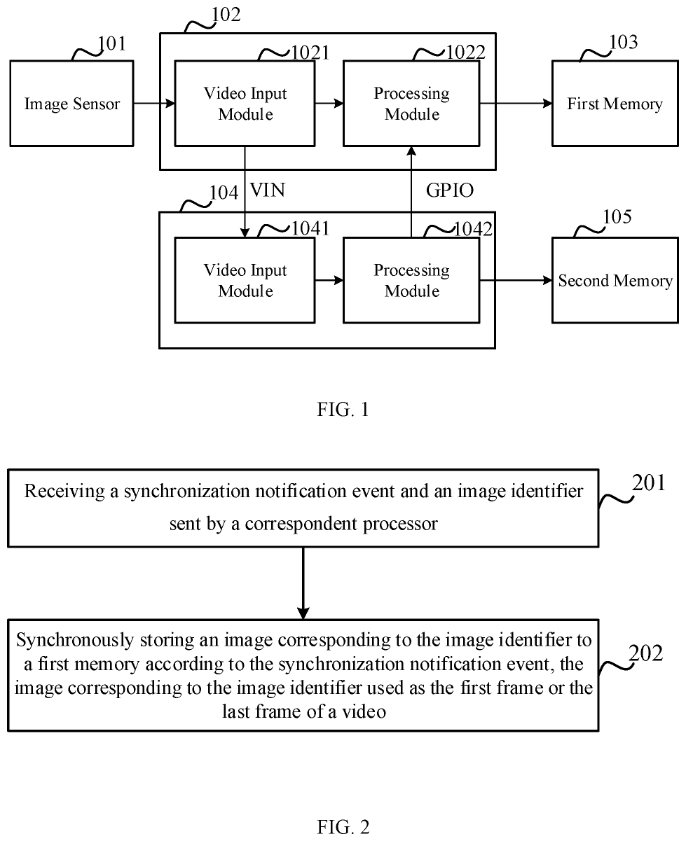

The present disclosure provides an image synchronized storage method. FIG. 1 illustrates a schematic diagram of an application scenario of an exemplary image synchronized storage method according to various embodiments of the present disclosure. Referring to FIG. 1, the disclosed image synchronized storage method may be applied to an image processing device including two processors. The image processing device may be an image processing device such as a camera, a webcam, or a mobile device such as an unmanned aerial vehicle (UAV), a control terminal, a smart phone, etc.

As shown in FIG. 1, the image processing device may include an image sensor 101, a processor 102, a first memory 103, a processor 104, and a second memory 105. The processor 102 may include a video input module (VIM) 1021 and a processing module 1022; the processor 104 may include a video input module 1041 and a processing module 1042. The connection between the processor 102 and the processor 104 may be as follows: the video input module 1021 and the video input module 1041 may be connected through a VIM interface, and the processing module 1042 and the processing module 1022 may be connected through a general purpose input/output (GPIO) interface. The number of the pins of the GPIO interface may be n, where n is a positive integer. The first memory 103 may be connected to the processor 102 and the second memory 105 may be connected to the processor 104.

It should be noted that in one embodiment, the number of pins of the GPIO interface may be larger than or equal to 2, that is, n≥2. The number of the pins of the GPIO interface, i.e. n, may be set according to the actual scenario of the application, and is not specifically limited by the embodiments of the present disclosure.

It should be noted that since there are two processors in the same device (e.g. the image processing device), in the following, for illustrative purposes, when describing the processing of one of the two processors, the other processor may be referred as to a correspondent processor of the processor. For example, referring to FIG. 1, when describing the processor 102, the processor 104 may be understood as a correspondent processor of the processor 102; when describing the processor 104, the processor 102 may be understood as a correspondent processor of the processor 104. The term “correspondent” is only used to distinguish the two processors that have an interaction relationship.

It should be noted that the processor 102 and the correspondent processor 104 may be separately provided in different devices. For example, the processor 102 may be included in one device, and the processor 104 may be included in another device. In one embodiment, the processor 102 and the correspondent processor 104 may be disposed in a same device at the same time. In some embodiments, the processor 102 and the correspondent processor 104 may be implemented by a same processor, that is, a single processor may be able to realize the functions of the processor 102 and the functions of the correspondent processor 104. For illustrative purposes, a case where two processors are provided in the same device is described as an example in the present disclosure.

In practical application, the first memory 103 may be implemented using an SSD, and the second memory 105 may be implemented using a SD card. In some embodiments, the first memory 103 and the second memory 105 may be a same memory, e.g. an SSD, or may be implemented using other memories selected according to the actual scenario of the application, which are not specifically limited by the embodiments of the present disclosure.

Based on the application scenario illustrated in FIG. 1, the present disclosure provides an image synchronized storage method. FIG. 2 illustrates a schematic flowchart of an exemplary image synchronized storage method according to various embodiments of the present disclosure. Referring to FIG. 2, the image synchronized storage method may include the following exemplary steps.

In 201, the method may include receiving a synchronization notification event and an image identifier sent by a correspondent processor.

In one embodiment, according to a trigger instruction of a user, the image sensor 101 may capture a video in the framing range. The video may contain a plurality of original images in the raw format, which will be referred to as raw images below.

The processor 102 may be connected to the image sensor 101, may receive the raw images transmitted by the image sensor 101, and may then transparently transmit the raw images to the correspondent processor 104 through the VIM interface. In addition, the processor 102 may receive a synchronization notification event and an image identifier sent by the correspondent processor through the GPIO interface. In one embodiment, the time of the processor 102 receiving the synchronization notification event may be earlier than the time of the processor 102 receiving the image identifier.

The synchronization notification event may refer to an instruction for triggering the processor 102 to start or end an image synchronization storage process. The synchronization notification event may be generated by the correspondent processor 104 or an event generating device according to a trigger instruction of the user (for example, a trigger action of the user to start recording video or end recording video).

In one embodiment, the synchronization notification event may include a first frame synchronization notification event and a last frame synchronization communication event. The synchronization notification event may be sent by the correspondent processor 104 through the GPIO interface. For example, the synchronization notification event may be 0 and 2ⁿ−1. When the number changes from 0 to 2ⁿ−1, it may indicate that the processor 102 receives the synchronization notification event. At this time, the synchronization notification event may be a rising-edge triggered event. In another example, the GPIO interface may use a first 0 or 2ⁿ−1 output to indicate a first frame synchronization notification event, and a second 0 or 2ⁿ−1 output to indicate a last frame synchronization notification event. At this time, the notification event may be a level triggered event.

In other embodiments, the processor 102 and the correspondent processor 104 may receive a synchronization notification event sent by an event generating device, and the event generating device may generate the synchronization notification event described above according to a user-triggered event. For the details of the process, reference may be made to the generation process in the description of the correspondent processor 104, which will be provided later.

When the received synchronization notification event is a first frame synchronization notification event, the processor 102 may start numbering the frame images from the next frame image. In one embodiment, the processor 102 may number the images in a video in a frame-by-frame increment and loop counting manner. For example, the processor 103 may number the images in the video using:

1,2,3,4, . . . 2ⁿ−2; . . . 1,2,3,4, . . . 2ⁿ−2.

In one embodiment, the number used for numbering a frame image in a plurality of consecutive frame images may be the image identifier of the frame image.

It should be noted that, in one embodiment, the reason for using 2ⁿ−2 as the maximum value of the image numbers (e.g. the maximum image identifier) is: 2ⁿ−1 may be used to indicate a synchronization notification event. When only 0 is used to indicate the synchronous notification event, the maximum value of the image numbers may be 2ⁿ−1. In other embodiments, according to the specific application scenario, the maximum number of the image numbers may be set to less than 2ⁿ−2.

In addition, in one embodiment, the loop count may be related to the cache depth of the processor 102 due to the following reasons. A certain time is required for the processor 102 to receive the synchronization notification event and transparently transmit the raw images to the processor 104, and also for the processor 104 to subsequently process the raw images. In order to avoid problems such as missing frames or data overflow, the processor 102 may be required to be able to cache a certain number of raw images in this process, so as to ensure that the processor 102 is able to find the first video image corresponding to the image identifier from the cache. In one embodiment, the buffer depth of the processor 102 may be a raw image with 2ⁿ−2 frames, that is, the maximum image identifier that can be transmitted by the GPIO interface.

In the embodiments of the present disclosure, for a frame image in a plurality of consecutive frame images included in a video, the image identifier of the frame image may refer to the number used to number the frame image. In one embodiment, the image identifier may be a universal unique identifier (UUID), and the UUID may be a 128-bit identifier, which can meet the requirements for numbering the images during a video recording process. In other embodiments, the image identifier may also be generated according to parameters such as the receiving time, the image data, the identification code of the image sensor, etc. which are not specifically limited by the embodiments of the present disclosure.

In 202, the method may include synchronously storing an image corresponding to the image identifier to a first memory according to the synchronization notification event. The image corresponding to the image identifier may be used as the first frame or the last frame of the video.

When the synchronization notification event is a first frame synchronization notification event, upon receiving the image identifier, the processor 102 may search for the corresponding image from the numbered images according to the image identifier, and start storing the corresponding image in the first memory 103. When the synchronization notification event is a last frame synchronization notification event, upon receiving the image identifier, the processor 102 may continue to store images until reaching the image corresponding to the image identifier.

In one embodiment, the images stored by the processor 102 may be images in the raw format, that is, the original images collected by the image sensor. Due to the large amount of image data in the raw format, in order to improve the storage speed, the first memory 103 may be implemented by a solid-state hard disk SSD. In other embodiments, other forms of storage devices may be used for implementation, and correspondingly, adjustments may need to be made according to the cache depth of the processor 102 and the acquisition speed of the image sensor to implement the technical scheme of the present disclosure.

In one embodiment, according to the disclosure technical scheme, the processor and the correspondent processor communicate to each other to achieve the goal of synchronously storing the first frame image and the last frame image of a video, such that the user can quickly confirm the images in memory, thereby facilitating the later material editing.

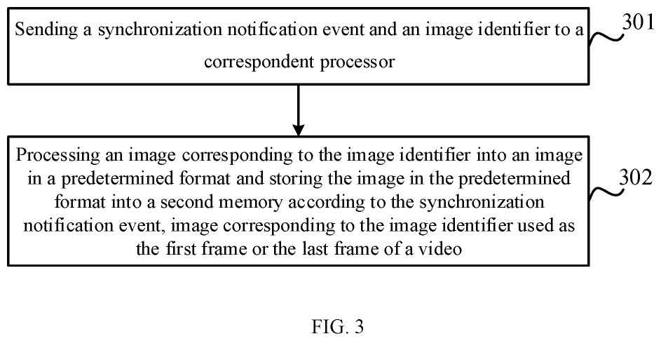

The present disclosure provides an image synchronized storage method. FIG. 3 illustrates a schematic flowchart of another exemplary image synchronized storage method according to various embodiments of the present disclosure. Referring to FIG. 3, the image synchronized storage method may include the following exemplary steps.

In 301, the method may include sending a synchronization notification event and an image identifier to a correspondent processor.

The processor 104 may be connected to the correspondent processor 102 through a GPIO interface, and may send a synchronization notification event and an image identifier through the GPIO interface. The number of the pins of the GPIO interface may be n, where n is a positive integer.

In one embodiment, the processor 104 may be the initiator for starting and ending the synchronous image storing. The start and end initiation actions may be generated based on trigger actions to start video recording and end video recording.

When receiving a trigger action corresponding to starting video recording, the processor 104 may send a first frame synchronization notification event to the correspondent processor 102 through the GPIO interface. After sending a first frame synchronization notification event, the processor 104 may start numbering the frame images from the next frame image. For the process of numbering, reference may be made to the corresponding description for FIG. 2 and the exemplary step 201, and the details are not described herein again. The processor 104 may determine the image identifier of the first frame image from the numbered images, and send the image identifier to the correspondent processor 102.

When receiving the trigger action corresponding to ending video recording, the processor 104 may send a last frame synchronization notification event to the correspondent processor 102 through the GPIO interface. After sending the last frame synchronization notification event, the processor 104 may calculate the last frame image of the video, and send the image identifier of the last frame image to the correspondent processor 102.

In one embodiment, because the processor 104 determines the image identifier of the first or last frame image of the video after sending the synchronization notification event, the time of the processor 104 sending the synchronization notification event may be earlier than the time of the processor 104 sending the image identifier.

In addition, during the process of the correspondent processor 102 transparently transmitting the raw image to the processor 104, when the processor 104 sends a synchronization notification event at this time, the start frames defined by the two processors may have different numbers. In order to ensure the accuracy of synchronization, in one embodiment, the processor 104 may send the synchronization notification event and the image identifier between two image frames, thereby avoiding the problem that the two processors have different image numbers.

It should be understood that, in the embodiments of the present disclosure, the synchronization notification event may be generated by an event generating device. That is, the event generating device may generate a synchronization notification event according to a trigger instruction of a user, and then send the synchronization notification event to the processor 102 and the processor 104 at the same time. For example, when the synchronization notification event is a first frame synchronization notification event, the processor 102 and the correspondent processor 104 may number the next frame of the raw image. After determining the image identifier of the first frame image, the correspondent processor 104 may send the image identifier to the processor 102. In another example, when the synchronization notification event is a last frame synchronization notification event, the processor 102 may prepare for receiving an image identifier, and at the same time, the correspondent processor 104 may determine the image identifier of the last frame image and send the image identifier to the processor 102. Then, the processor 102 and the correspondent processor 104 may continue to store the images until reaching the last frame image.

In other embodiments, determining the image identifiers corresponding to the first and last frame images may be performed by the processor 102. For example, when transparently transmitting the raw images, the processor 102 may also number the raw images, and when sending the synchronization notification event, the processor 102 may use the raw image after the synchronization notification event as the first frame image or the last frame image. The processor 104 may process and store the raw images according to the first frame synchronization notification event, or stop processing the raw image according to the last frame synchronization notification event.

In 302, the method may include processing an image corresponding to the image identifier into an image in a predetermined format and storing the image in the predetermined format into a second memory according to the synchronization notification event. The image corresponding to the image identifier may be used as the first frame or the last frame of the video.

In one embodiment, the synchronization notification event may be a first frame synchronization notification event, and when determining the image identifier of the first frame image, the processor 104 may start processing the image corresponding to the image identifier into an image in a predetermined format and then stores the image in the predetermined format in the second memory 105 synchronously.

In one embodiment, the synchronization notification event may be a last frame synchronization notification event, when determining the image identification of the last frame image, the processor 104 may, after continuously processing the image into an image in the predetermined format, store the image in the predetermined format in the second memory 105 synchronously.

In one embodiment, the predetermined format may be the tagged image file format (TIFF) or the joint photographic experts group (JPEG) format. In other embodiments, other formats may be used, which are not specifically limited by the embodiments of the present disclosure. Because the processed image data in the predetermined format is small, the second memory 105 may be implemented by an SD card. In other embodiments, other forms of storage devices may be used for implementation, and correspondingly, adjustments may need to be made according to the processing depth of the processor 104 and the acquisition speed of the image sensor to implement the technical scheme of the present disclosure.

In one embodiment, according to the disclosure technical scheme, the processor 104 initiates synchronous communication, and cooperates with the correspondent processor 102 to achieve the goal of synchronously storing the first frame image and the last frame image of a video, such that the user can quickly confirm the images in memory, thereby facilitating the later material editing.

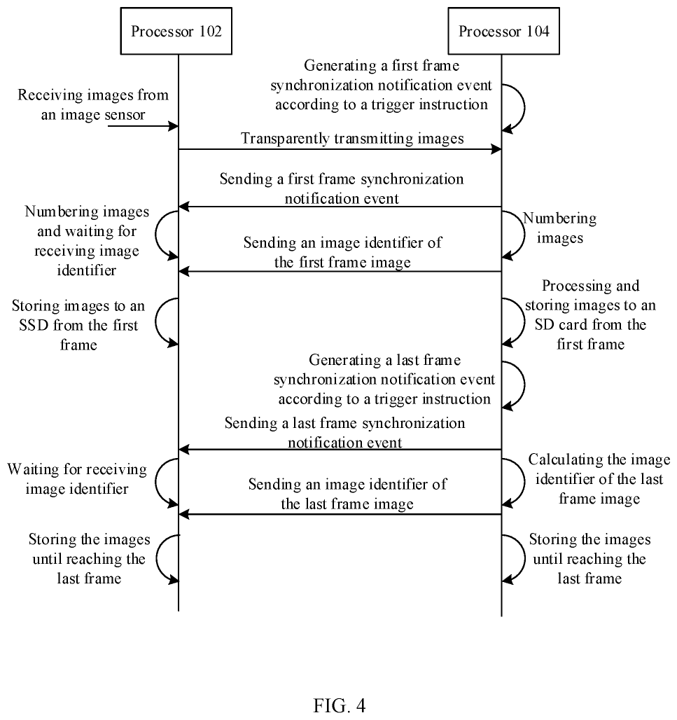

FIG. 4 illustrates a schematic flowchart of another exemplary image synchronized storage method according to various embodiments of the present disclosure. In the following, the interaction process between the processor 102 and the processor 104 is described in detail with reference to FIGS. 1-4. Referring to FIGS. 1-4, the image synchronized storage method may include the following exemplary steps.

The processor 102 may cache a video from the image sensor 101, and may transparently transmit the video to the processor 104.

When the trigger action is received, the processor 104 may be the initiator for starting and ending the synchronous image storing. The start and end initiation actions, e.g., the synchronization notification events, may be generated based on trigger actions to start video recording and end video recording. Then, the processor 104 may send the first frame synchronization notification event through the GPIO interface. The processor 104 may start numbering the raw images from the raw image of the next frame after sending the first frame synchronization notification event.

In one embodiment, the processor 104 may number the raw images from the next frame after receiving the first frame synchronization notification event, and use the number as the image identifier for each raw image. During this process, the processor 102 may wait to receive the image identifier.

In one embodiment, after completing the numbering of all or part of the images, the processor 104 may determine the image identifier of the first frame image of the video, and send the image identifier to the processor 102 through the GPIO interface.

Further, the processor 104 may start processing the raw image into an image of a predetermined format, and store the processed image of the predetermined format into an SD card synchronously. In one embodiment, the predetermined format may be the TIFF format or the JPEG format. In other embodiments, other formats may be used, which are not specifically limited by the embodiments of the present disclosure.

Correspondingly, after receiving the image identifier, the processor 102 may search for the corresponding image from the already numbered images according to the image identifier, and start to store the image. In one embodiment, the processor 102 may store the image in an SSD.

As such, the processor 102 and the correspondent processor 104 have completed the synchronized storage of the first frame image of the video.

After the synchronized storage is completed, the image sensor may continuously collect the images, and the processor 102 and the processor 104 may then store the images to the SSD and the SD respectively according to the technical scheme described above.

In one embodiment, when the video recording time ends or the user triggers an end operation, the processor 104 may generate a last frame synchronization notification event according to the trigger event, and the last frame synchronization notification event may be sent to the processor 102 through the GPIO interface. After receiving the last frame synchronization notification event, the processor 102 may switch to a last frame synchronization state to prepare for receiving the image identifier sent by the processor 104.

In one embodiment, after sending the last frame synchronization notification event, the processor 104 may calculate the last frame image of the video and send the image identifier of the last frame image to the processor 102. At the same time, the processor 104 may continuously store the images until reaching the last frame image.

In one embodiment, the method for the processor 104 to calculate the last frame image may include: starting timing when a trigger instruction is received, and when the timing reaches a predetermined duration, using the image corresponding to the last moment or the last frame within the predetermined duration as the last frame of the video. Alternatively, in other embodiments, the method for the processor 104 to calculate the last frame image may include: starting counting when a trigger instruction is received, and after counting a predetermined number of frame images, using the last frame of the predetermined number of frame images as the last frame of the video. It should be understood that those skilled in the art may set a calculation method according to a specific application scenario, and the corresponding calculation method should also fall into the protection scope of the present disclosure.

In one embodiment, after receiving the image identifier of the last image frame, the processor 102 may continue to store the images until reaching the last frame image that corresponds to the image identifier.

As such, the processor 102 and the correspondent processor 104 have completed the synchronized storage of the last frame image of the video.

Therefore, according to the embodiment of the present disclosure, through the communication between the processor 102 and the processor 104, the goal of synchronously storing the first frame image and the last frame image of a video may be achieved, such that the user can quickly confirm the images in memory, thereby facilitating the later material editing.

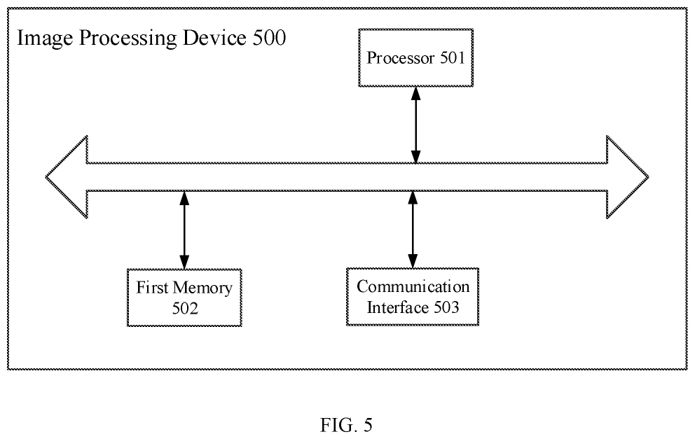

The present disclosure also provides an image processing device. FIG. 5 illustrates a schematic structural diagram of an exemplary image processing device according to various embodiments of the present disclosure. Referring to FIG. 5, the image processing device 200 may include a processor 501, a first memory 502, and a communication interface 503. The processor 501 may be connected to a correspondent processor (not shown in FIG. 5) through the communication interface 503. The processor 501 may be configured to:

receive a synchronization notification event and an image identifier sent by the correspondent processor; and

synchronously store an image corresponding to the image identifier to the first memory according to the synchronization notification event, where the image corresponding to the image identifier is used as the first frame or the last frame of a video.

In one embodiment, the synchronization notification event may be received before the image identifier.

In one embodiment, after receiving the synchronization notification event sent by the correspondent processor, the processor 501 may be further configured to: when the synchronization notification event is a first frame synchronization notification event, start numbering the frame images from the next frame image.

In one embodiment, after receiving the synchronization notification event sent by the correspondent processor, the processor 501 may be further configured to:

when the synchronization notification event is a last frame synchronization notification event, switch to a last frame synchronization state to prepare for receiving the image identifier sent by the correspondent processor.

In one embodiment, after storing the image corresponding to the image identifier to the first memory 502 according to the synchronization notification event, the processor 501 may be further configured to:

when the image corresponding to the image identifier is the first frame of the video, continue to store images after the image identifier.

In one embodiment, prior to storing the image corresponding to the image identifier to the first memory according to the synchronization notification event, the processor may be further configured to:

when the image corresponding to the image identifier is the last frame of the video, continue to store images until reaching the image corresponding to the image identifier.

In one embodiment, the communication interface 503 may include a GPIO interface, and the processor 501 may be configured to transmit the synchronization notification event to the correspondent processor through the GPIO interface.

In one embodiment, the processor 501 may be capable of caching at least 2ⁿ−2 frame images, where n is the number of the pins of the GPIO interface.

In one embodiment, the processor 501 may also be configured to:

transparently transmit images from an image sensor to the correspondent processor.

In one embodiment, the first memory may be an SSD.

In one embodiment, the images may adopt the raw format.

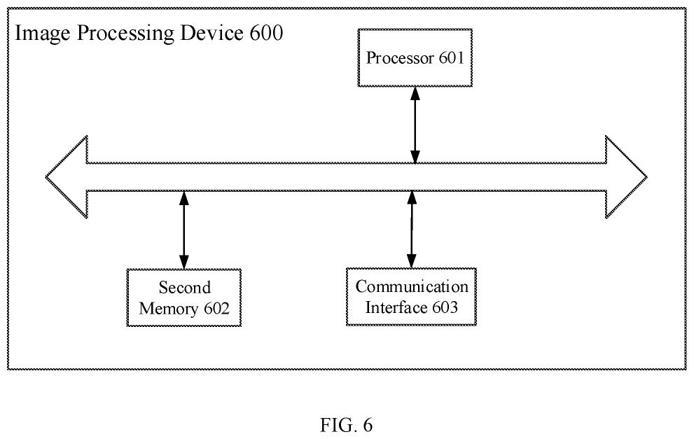

The present disclosure also provides an image processing device. FIG. 6 illustrates a schematic structural diagram of another exemplary image processing device according to various embodiments of the present disclosure. Referring to FIG. 6, the image processing device 600 may include a processor 601, a second memory 602, and a communication interface 603. The processor 601 may be connected to a correspondent processor (not shown in FIG. 6) through the communication interface 603. The processor 601 may be configure to:

send a synchronization notification event and an image identifier to the correspondent processor; and

process the image corresponding to the image identifier into an image in a predetermined format and store the image in the predetermined format into the second memory according to the synchronization notification event, where the image corresponding to the image identifier is used as the first frame or the last frame of a video.

In one embodiment, the synchronization notification event may be sent before the image identifier.

In one embodiment, after sending the synchronization notification event to the correspondent processor, the processor 601 may be further configured to:

when the synchronization notification event is a first frame synchronization notification event, start numbering the frame images from the next frame image.

In one embodiment, after starting numbering the frame images from the next frame image, the processor 601 may be further configured to:

determine a first frame image from the numbered images.

In one embodiment, after sending the synchronization notification event to the correspondent processor, the processor 601 may be further configured to:

when the synchronization notification event is a last frame synchronization notification event, calculate the image identifier of the last frame image.

In one embodiment, when processing the image corresponding to the image identifier into the image in the predetermined format and store the image in the predetermined format into the second memory according to the synchronization notification event, the processor 601 may be further configured to:

when the image corresponding to the image identifier is the first frame of the video, continue to process images after the image identifier into images in the predetermined format and store the images in the predetermined format into the second memory.

In one embodiment, when processing the image corresponding to the image identifier into the image in the predetermined format and store the image in the predetermined format into the second memory according to the synchronization notification event, the processor 601 may be further configured to:

when the image corresponding to the image identifier is the last frame of the video, continue to process images into images in the predetermined format and store the images in the predetermined format into the second memory until reaching the image corresponding to the image identifier.

In one embodiment, the communication interface 603 may include a GPIO interface, and the processor 601 may be configured to transmit the synchronization notification event to the correspondent processor through the GPIO interface.

In one embodiment, the processor 601 may also be configured to:

receive images from an image sensor and transparently transmitted through the correspondent processor.

In one embodiment, the processor 601 may be configured to:

acquire a trigger instruction, and generate the synchronization notification event according to the trigger instruction.

In one embodiment, the second memory 502 may be an SD card.

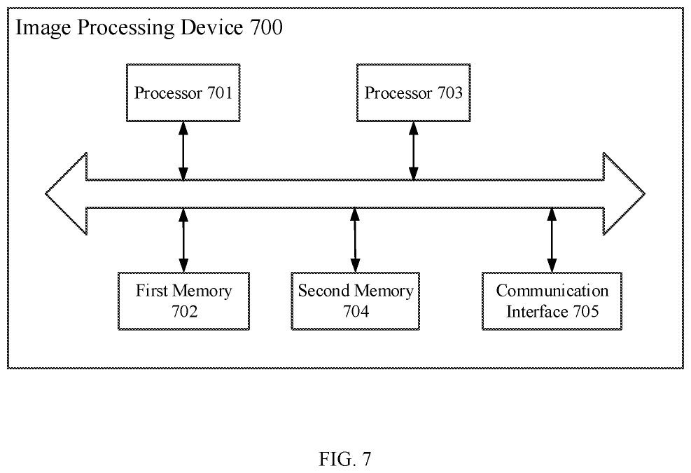

The present disclosure further provides an image processing device. FIG. 7 illustrates a schematic structural diagram of another exemplary image processing device according to various embodiments of the present disclosure. Referring to FIG. 7, the image processing device 700 may include a processor 701, a first memory 702, a correspondent processor 703, a second memory 704, and a communication interface 705. The processor 701 may be connected with the correspondent processor 703 through the communication interface 705.

The processor 701 may be configured to send a synchronization notification event and an image identifier to the correspondent processor 703.

The correspondent processor 703 may be configured to synchronously store an image corresponding to the image identifier to the first memory 702 according to the synchronization notification event, and the processor 701 may be further configured to process the image corresponding to the image identifier into an image in a predetermined format and store the image in the predetermined format into the second memory 704 according to the synchronization notification event, where the image corresponding to the image identifier is used as the first frame or the last frame of a video.

In one embodiment, the communication interface 705 may include a GPIO interface. The processor 701 may be further configured to send the synchronization notification event and the image identifier to the correspondent processor 703 through the communication interface 705.

In one embodiment, the correspondent processor 703 may be further configured to receive images from an image sensor (not shown), and transparently transmit the images to the processor 701.

In one embodiment, the synchronization notification event may include a first frame synchronization notification event and a last frame synchronization notification event.

In one embodiment, after the processor 701 sends the synchronization notification event to the correspondent processor 703, the processor 701 and the correspondent processor 703 may be further configured to:

when the synchronization notification event is a first frame synchronization notification event, start numbering the frame images from the next frame image.

In one embodiment, prior to the processor 701 sends the synchronization notification event to the correspondent processor 703, the processor 701 may be further configured to:

acquire a trigger instruction from a user; and

generate the synchronization notification event according to the trigger instruction.

In one embodiment, when the synchronization notification event is a last frame synchronization notification event, the correspondent processor 703 may be further configured to switch to a last frame synchronization state to prepare for receiving the image identifier sent by the processor 701.

In one embodiment, after the processor 701 sends the image identifier of an image to the correspondent processor 703, when the image corresponding to the image identifier is the first frame of the video, the processor 701 may be configured to continue to store images after the image identifier; and

the correspondent processor 703 may be configured to continue to process images after the image identifier.

In one embodiment, before the processor 701 sends the image identifier of an image to the correspondent processor 703, when the image corresponding to the image identifier is the last frame of the video, the processor 701 may be configured to continue to store images until reaching the image corresponding to the image identifier; and

the correspondent processor 703 may be configured to continue to store images until reaching the image corresponding to the image identifier.

In one embodiment, the processor 701 may be further configured to send the synchronization notification event between two images, such that the correspondent processor 703 may receive the synchronization notification event before sending the next frame image.

In one embodiment, the processor 701 may be capable of caching at least 2ⁿ−2 frame images, where n is the number of the pins of the GPIO interface.

The present disclosure also provides a computer readable storage medium. The computer readable storage medium may store a plurality of computer instructions. When the computer instructions are executed, the following operations may be implemented:

receiving a synchronization notification event and an image identifier sent by a correspondent processor; and

synchronously storing an image corresponding to the image identifier to a first memory according to the synchronization notification event, where the image corresponding to the image identifier is used as the first frame or the last frame of a video.

The present disclosure also provides a computer readable storage medium. The computer readable storage medium may store a plurality of computer instructions. When the computer instructions are executed, the following operations may be implemented:

sending a synchronization notification event and an image identifier to a correspondent processor; and

processing the image corresponding to the image identifier into an image in a predetermined format and storing the image in the predetermined format into a second memory according to the synchronization notification event, where the image corresponding to the image identifier is used as the first frame or the last frame of a video.

The present disclosure also provides a computer readable storage medium. The computer readable storage medium may store a plurality of computer instructions. When the computer instructions are executed, the following operations may be implemented:

a processor sending a synchronization notification event and an image identifier to a correspondent processor; and

the correspondent processor synchronously storing an image corresponding to the image identifier to a first memory according to the synchronization notification event, and the processor processing the image corresponding to the image identifier into an image in a predetermined format and storing the image in the predetermined format into a second memory according to the synchronization notification event, where the image corresponding to the image identifier is used as the first frame or the last frame of a video.

It should be noted that in the present disclosure, relational terms such as first and second are used only to distinguish one entity or operation from another entity or operation, and do not necessarily require or imply that these entities or operations have any such actual relationship or order. The term “comprising”, “including” or any other variation is intended to encompass non-exclusive inclusion, such that a process, method, article, or device that includes a series of elements includes not only those elements but also other elements that are not explicitly listed, or elements that are inherent to such a process, method, article, or device. Without more restrictions, the elements defined by the sentence “including a . . . ” do not exclude the existence of other identical elements in the process, method, article, or equipment that includes the elements.

It should be noted that, under the premise of no conflict, the embodiments described in this application and/or the technical features in each embodiment can be arbitrarily combined with each other, and the technical solution obtained after the combination should also fall into the protection scope of this application.

Those of ordinary skill in the art may understand that the units and algorithm steps of each example described in combination with the embodiments disclosed herein can be implemented by electronic hardware, or a combination of computer software and electronic hardware. Whether these functions are performed in hardware or software depends on the specific application and design constraints of the technical solution. Those of ordinary skill in the art can use different methods to implement the described functions for each specific application, but such implementation should not be considered to be beyond the scope of this application.

In the various embodiments provided by the present application, it should be understood that the disclosed systems, devices, and methods may be implemented in other manners. For example, the device embodiments described above are merely illustrative. For instance, in various embodiments of the present disclosure, the units are divided or defined merely according to the logical functions of the units, and in actual applications, the units may be divided or defined in another manner. For example, multiple units or components may be combined or integrated into another system, or some features can be ignored or not executed. In addition, the mutual coupling or direct coupling or communication connection shown or discussed may be an indirect coupling or communication connection through some interface, device or unit, and may be in an electrical, mechanical, or other form.

The units described as separate components may or may not be physically separated, and the components displayed as a unit may or may not be physical in a unit, that is, they may be located in one place, or may be distributed to multiple network units. Some or all of the units may be selected according to actual needs to achieve the purpose of the solution of the embodiment.

In addition, each functional unit in each embodiment of the present application may be integrated into one processing unit, or each unit may exist physically separately, or two or more units may be integrated into one unit.

Finally, it should be noted that the above embodiments are merely illustrative of, but not intended to limit, the technical solutions of the present invention; although the present disclosure has been described in detail with reference to the above embodiments, those skilled in the art should understand that the technical solutions described in the above embodiments may be modified, or part or all of the technical features may be equivalently replaced; and the modifications or substitutions do not depart from the scope of the technical solutions of the embodiments of the present disclosure.

What is claimed is:

1. An image processing device, comprising:
a processor, a communication interface, and a first memory, wherein:
the processor is connected to a correspondent processor through the communication interface; and the processor is configured to:
receive a synchronization notification event and an image identifier sent by the correspondent processor; and
synchronously store an image corresponding to the image identifier to the first memory according to the synchronization notification event, wherein the image corresponding to the image identifier is used as a first frame or a last frame of a video.

2. The image processing device according to claim 1, wherein:
the synchronization notification event is received before the image identifier.

3. The image processing device according to claim 1, wherein after receiving the synchronization notification event sent by the correspondent processor, the processor is further configured to:
in response to the synchronization notification event being a first frame synchronization notification event, start numbering frame images from a next frame image.

4. The image processing device according to claim 1, wherein after receiving the synchronization notification event sent by the correspondent processor, the processor is further configured to:
in response to the synchronization notification event being a last frame synchronization notification event, switch to a last frame synchronization state to prepare for receiving an image identifier sent by the correspondent processor.

5. The image processing device according to claim 1, wherein after storing the image corresponding to the image identifier to the first memory according to the synchronization notification event, the processor is further configured to:
in response to the image corresponding to the image identifier being the first frame of the video, continue to store images after the image identifier.

6. The image processing device according to claim 1, wherein prior to storing the image corresponding to the image identifier to the first memory according to the synchronization notification event, the processor is further configured to:
in response to the image corresponding to the image identifier being the last frame of the video, continue to store images until reaching the image corresponding to the image identifier.

7. The image processing device according to claim 1, wherein:
the communication interface includes a general purpose input/output (GPIO) interface; and
the processor is configured to transmit the synchronization notification event to the correspondent processor through the GPIO interface.

8. The image processing device according to claim 7, wherein:
the processor is capable of caching at least 2ⁿ−2 frame images, wherein n is a number of pins of the GPIO interface.

9. The image processing device according to claim 1, wherein the processor is further configured to:
transparently transmit images from an image sensor to the correspondent processor.

10. The image processing device according to claim 1, wherein:
the first memory is a solid state drive (SSD).

11. An image processing device, comprising:
a processor, a communication interface, and a second memory, wherein:
the processor is connected to a correspondent processor through the communication interface; and the processor is configured to:
send a synchronization notification event and an image identifier to the correspondent processor; and
process an image corresponding to the image identifier into an image in a predetermined format and store the image in the predetermined format into the second memory according to the synchronization notification event, wherein the image corresponding to the image identifier is used as a first frame or a last frame of a video.

12. The image processing device according to claim 11, wherein:
the synchronization notification event is sent before the image identifier.

13. The image processing device according to claim 11, wherein after sending the synchronization notification event to the correspondent processor, the processor is further configured to:
in response to the synchronization notification event being a first frame synchronization notification event, start numbering frame images from a next frame image.

14. The image processing device according to claim 13, wherein after starting numbering the frame images from the next frame image, the processor is further configured to:
determine a first frame image from numbered images.

15. The image processing device according to claim 11, wherein after sending the synchronization notification event to the correspondent processor, the processor is further configured to:
in response to the synchronization notification event being a last frame synchronization notification event, calculate an image identifier of the last frame image.

16. The image processing device according to claim 11, wherein when processing the image corresponding to the image identifier into the image in the predetermined format and store the image in the predetermined format into the second memory according to the synchronization notification event, the processor is further configured to:
in response to the image corresponding to the image identifier being the first frame of the video, continue to process images after the image identifier to images in the predetermined format and store the images in the predetermined format into the second memory.

17. The image processing device according to claim 11, wherein when processing the image corresponding to the image identifier into the image in the predetermined format and store the image in the predetermined format into the second memory according to the synchronization notification event, the processor is further configured to:
in response to the image corresponding to the image identifier being the last frame of the video, continue to process images to images in the predetermined format and store the images in the predetermined format into the second memory until reaching the image corresponding to the image identifier.

18. The image processing device according to claim 11, wherein:
the communication interface includes a GPIO interface; and
the processor is configured to transmit the synchronization notification event to the correspondent processor through the GPIO interface.

19. The image processing device according to claim 11, wherein the processor is further configured to:
receive images from an image sensor and transparently transmitted through the correspondent processor.

20. The image processing device according to claim 11, wherein the processor is further configured to:
acquire a trigger instruction; and
generate the synchronization notification event according to the trigger instruction.
